(19) United States
(12) Patent Application Publication
(10) Pub. No.: US 2004/0121786 A1
(43) Pub. Date: Jun. 24, 2004

(54) Wireless communication method, system and apparatus

(75) Inventors: Keith S. Radcliffe, Meadows Place, TX (US); Robert P. Dart, Ponca City, OK (US)

Correspondence Address: PAUL S MADAN, MADAN, MOSSMAN & SRIRAM, PC, 2603 AUGUSTA, SUITE 700, HOUSTON, TX, 77057-1130, US

(73) Assignee: Input/Output Inc.

(21) Appl. No.: 10/679,858

(22) Filed: Oct. 6, 2003

Related U.S. Application Data
(60) Provisional application No. 60/416,006, filed on Oct. 4, 2002.

(51) Int. Cl. H04B 7/00

(52) U.S. Cl. 455/500

(57) ABSTRACT

The present invention, in certain embodiments, is a method, system and apparatus for information gathering, for example seismic data acquisition operations or utility services monitoring for homes, businesses and municipalities, using a wireless network with a virtual enabling data communication and storage over multiple environments, hardware systems and time frames. This WAN platform is capable of handling all communications for a seismic field crew or other information gathering organization. The invention provides near real-time dissemination of data across a mobile network to a destination system.

### CROSS REFERENCE TO RELATED APPLICATIONS

This application claims priority from U.S. Provisional App. Ser. No. 60/416,006 filed on Oct. 4, 2002.

### FIELD OF THE INVENTION

The present invention pertains generally to data acquisition using wireless ad-hoc networks, and more particularly to a method, system and apparatus of data acquisition with ad-hoc networks. The ad-hoc networks are useful in the fields of seismic data acquisition and utility usage monitoring and data acquisition.

### BACKGROUND OF THE INVENTION

A “mobile ad hoc network” (MANET) is an autonomous system of mobile routers (and associated hosts) connected by wireless links. The routers are free to move randomly and organize themselves arbitrarily; thus, the network's wireless topology may change rapidly and unpredictably. Such a network may operate in a standalone fashion, or may be connected to the larger Internet.

Ad-hoc networks, also known as multi-hop packet-radio networks, typically consist of mobile hosts that are interconnected by routers that can also move. This architecture is used when there is no wired infrastructure in place. Examples of such networks are networks set up in disaster or military scenarios, and networks set up at temporary events such as a class lecture or business convention. In most instances, not all stations are within line of sight of each other or a base station. Therefore, packets have to be relayed several times over multiple-access channels. Due to limited transmission range, mobility causes frequent changes in connectivity; that is, the network topology is dynamic. All the stations serve as both sources and relays of data traffic.

Due to the multihop and dynamic nature of ad-hoc networks, a distributed routing protocol is required to forward packets between mobile stations and to and from the Internet or any other access point (AP). Routers in an ad-hoc network can easily run routing protocols designed for wired networks. Wireless networks can suffer from low bandwidth and high rates of interference. This implies that routing protocols should generate as few updates as possible, so as to use the least possible bandwidth for control traffic. Mobility also increases the bandwidth used for control packets. As links go up and down frequently, more updates need to be sent to maintain correct topology information. As congestion due to control overhead increases, the convergence time of the routing algorithm increases.

A MANET consists of mobile platforms (e.g., a router with multiple hosts and wireless communications devices)—herein simply referred to as “nodes”—which are free to move about arbitrarily. The nodes may be located in or on airplanes, ships, trucks, cars, perhaps even on people or very small devices, and there may be multiple hosts per router. A MANET is an autonomous system of mobile nodes. The system may operate in isolation, or may have gateways to and interface with a fixed network. In the latter operational mode, it is typically envisioned to operate as a “stub” network connecting to a fixed internetwork.

Stub networks carry traffic originating at and/or destined for internal nodes, but do not permit exogenous traffic to “transit” through the stub network. MANET nodes are equipped with wireless transmitters and receivers using antennas which may be omnidirectional (broadcast), highly-directional (point-to-point), possibly steerable, or some combination thereof. At a given point in time, depending on the nodes' positions and their transmitter and receiver coverage patterns, transmission power levels and co-channel interference levels, a wireless connectivity in the form of a random, multihop graph or “ad hoc” network exists between the nodes. This ad hoc topology may change with time as the nodes move or adjust their transmission and reception parameters.

MANETs have several salient characteristics:

1. Dynamic topologies: Nodes are free to move arbitrarily; thus, the network topology—which is typically multihop—may change randomly and rapidly at unpredictable times, and may consist of both bidirectional and unidirectional links.

2. Bandwidth-constrained, variable capacity links: Wireless links will continue to have significantly lower capacity than their hardwired counterparts. In addition, the realized throughput of wireless communications—after accounting for the effects of multiple access, fading, noise, and interference conditions, etc.—is often much less than a radio's maximum transmission rate. One effect of the relatively low to moderate link capacities is that congestion is typically the norm rather than the exception, i.e. aggregate application demand will likely approach or exceed network capacity frequently. As the mobile network is often simply an extension of the fixed network infrastructure, mobile ad hoc users will expect similar services. These expectations continue to increase as multimedia computing and collaborative networking applications rise.

3. Energy-constrained operation: Some or all of the nodes in a MANET may rely on batteries or other exhaustible means for their energy. For these nodes, the most important system design criteria for optimization may be energy conservation.

4. Limited physical security: Mobile wireless networks are generally more prone to physical security threats than are fixed cable nets. The increased possibility of eavesdropping, spoofing, and denial-of-service attacks should be carefully considered. Existing link security techniques are often applied within wireless networks to reduce security threats. As a benefit, the decentralized nature of network control in MANETs provides additional robustness against the single points of failure of more centralized approaches. In addition, some envisioned networks (e.g. mobile military networks or highway networks) may be relatively large (e.g. tens or hundreds of nodes per routing area). The need for scalability is not unique to MANETS. However, in light of the preceding characteristics, the mechanisms required to achieve scalability likely are. These characteristics create a set of underlying assumptions and performance concerns for protocol design which extend beyond those guiding the design of routing within the higher-speed, semi-static topology of the fixed Internet.

Heretofore, as is well known in the oil industry services sectors and is also known in utility monitoring and information gathering, there has been a need for a method, system and apparatus to facilitate rapid communication that is not restricted by hardware or topography. Additionally, this method, system and apparatus should provide for improved communication across groups and industries, and be applicable in other environments, and adaptable in real time to changing circumstances. Accordingly, it should now be recognized, as was recognized by the present inventors, that there exists a need for a method, system and apparatus address and solve the above-described problems.

Before proceeding to a description of the present invention, however, it should be noted and remembered that the description of the invention which follows, together with the accompanying drawings, should not be construed as limiting the invention to the examples (or preferred embodiments) shown and described. This is so because those skilled in the art to which the invention pertains will be able to devise other forms of this invention within the scope of the appended claims.

### SUMMARY OF THE INVENTION

The present invention, in certain embodiments, is a method, system and apparatus for information gathering, for example seismic data acquisition operations or utility services monitoring for homes, businesses and municipalities, using a wireless network with a virtual enabling data communication and storage over multiple environments, hardware systems and time frames. This WAN platform is capable of handling all communications for a seismic field crew or other information gathering organization. The invention provides near real-time dissemination of data across a mobile network to a destination system.

### BRIEF DESCRIPTION OF THE DRAWINGS

The novel features which are believed to be characteristic of the invention, both as to organization and methods of operation, together with the objects and advantages thereof, will be better understood from the following detailed description and the drawings wherein the invention is illustrated by way of example for the purpose of illustration and description only and are not intended as a definition of the limits of the invention:

FIG. 1 is flow chart of a SeisWAN node;

FIG. 2 illustrates a Contention Window;

FIG. 3 illustrates a data packet to be sent over the wireless network;

FIG. 4 is flow chart of an alternate SeisWAN node; and

FIG. 5 is flow chart of the SeisWAN network on a seismic field operation.

While the invention will be described in connection with its preferred embodiments, it will be understood that the invention is not limited thereto. On the contrary, it is intended to cover all alternatives, modifications, and equivalents that may be included within the spirit and scope of the invention, as defined by the appended claims.

### DETAILED DESCRIPTION OF THE PREFERRED EMBODIMENT

For the purpose of clarity and explanation, the method of this invention will be described by way of example, but not by way of limitation, with respect to seismic data acquisition systems using Wireless systems, or a seismic WAN. It will be understood that the invention is applicable to a wide range of information gathering endeavors, for example utility services monitoring for homes, businesses and municipalities. The present invention provides for near real-time dissemination of data across a mobile network to and within a destination system. It is to be clearly understood that the method may be applied to any data recording, positioning or acquisition system and is not limited in terms of the particular example embodiments outlined herein.

The method, system and apparatus of the present invention is software based and media independent. The invention allows for continued hardware scaling without being dependent on any single platform. The invention adds functionality to current acquisition equipment and systems, and can be added without interrupting system operations.

The method, system and apparatus of the present invention is built upon a mobile ad-hoc network (MANET) that can meet all the needs and constraints of seismic operations or any highly mobile organization requiring dynamic adaptations of communication infrastructure.

A MANET is formed by a cluster of mobile hosts (or nodes), each installed with a wireless transceiver, without the assistance of base stations. Due to the transmission range constraint of transceivers, two mobile hosts can communicate with each other either directly, if they are close enough, or indirectly, by having other mobile hosts relay their packets. This type of network can dynamically adapt to a continually changing topology of nodes.

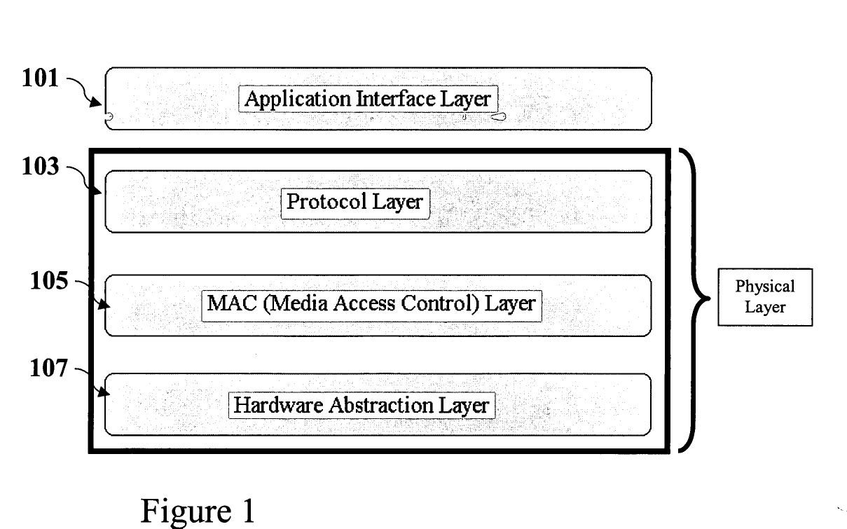

Each SeisWAN node is a node on the network. Each physical layer (FIG. 1) comprises a module (with layers) for a Protocol Layer 103, Media Access Control 105 (MAC) Layer, and a Hardware Abstraction Layer 107. These three modules, together, represent the SeisWAN node and are responsible for all communication requirements. These communication requirements include receiving data, receiving packets, and sending packets.

The Hardware Abstraction Layer 107 is operating system and hardware specific, and is responsible for all communications with the OS and hardware. This layer is responsible for the actual transfer of data between the OS/hardware and the other two layers. The particular choice of operating system is not critical to the method, system and apparatus. With the modular design of the present invention, updating the hardware abstraction layer for a new operating system or new hardware has a minimal possible cost.

The MAC Layer 105 is responsible for insuring that packets are sent and received properly between two nodes. This layer will insure that it does not send data to a destination radio when another radio in its area is already transmitting. To accomplish this task, this layer will use a modified form of the standard Ethernet protocol Carrier Sense Multiple Access with Collision Detection (CSMA/CD).

The most important difference between a wired and a wireless network is the impossibility to detect collisions. When a node is transmitting data, it is unable to see any signal but its own. Because of this, it is very important that collisions be avoided. To avoid collisions, each node must “request” time to send data on the network. This protocol is known as Carrier Sense Multiple Access with Collision Avoidance (CSMA/CA).

The idea behind CSMA/CA is for nodes to compete for transmission time. Each node will “request” transmission time from the target node using a Request To Transmit (RTS) message. This “request” period is known as the “Contention Window”. The contention window is divided into time slices. Each slice has a RTS and a CTS (clear to send) block separated by Short Inter-Frame Spacings (SIFS). The first node to send a RTS will probably be the node to receive a CTS. This may not be the case if a collision occurs during the RTS transmission.

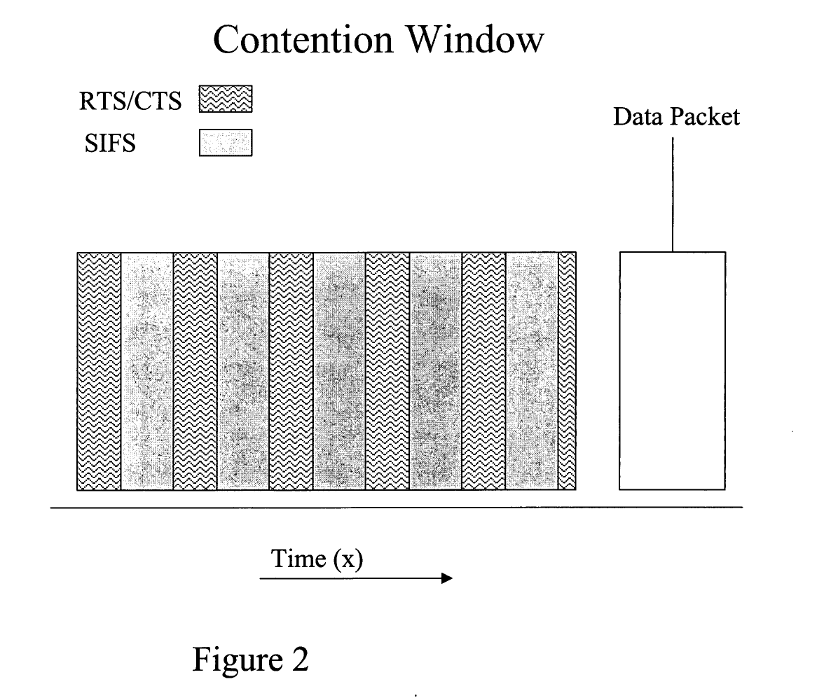

The contention window (FIG. 2) is divided into time slices. Each node that wishes to send a request will send a RTS message in one of the slots in the contention window. The slot is chosen at random using a random number generator. This helps to reduce collisions of RTS messages. If a collision does occur, then the requesting node will not receive a CTS message and will wait for a random back-off period before trying again. If a transmission begins before the end of the back-off period, then the node will wait until the next contention window before sending another RTS.

There will be a minimum number of slots in the contention window, but no maximum. This means that if no node has requested a slot and no recipient has replied with a CTS, then the contention window remains open.

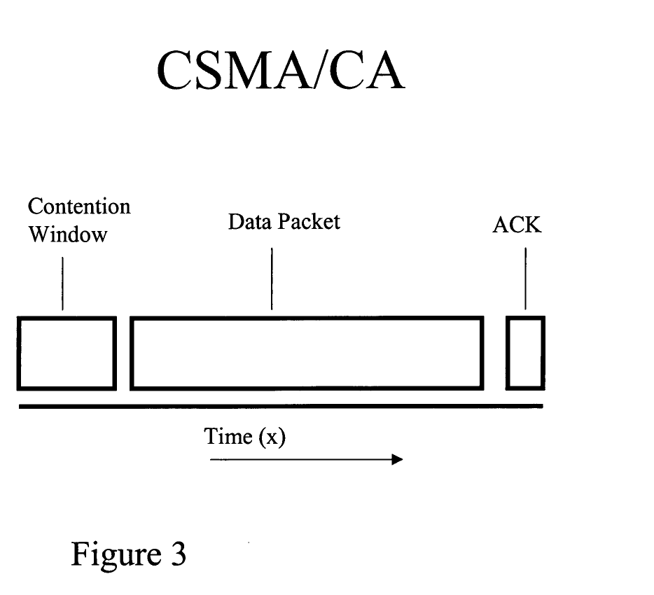

FIG. 3 is an illustration of the CMSA/CA procedure. After the RTS has been answered with a CTS, the data are sent, followed by an acknowledgment ACK. The Protocol Layer is responsible for route discovery, data forwarding, and route maintenance. Where the MAC layers responsibility was to send and receive data from one radio to another, the protocol layers responsibility is to insure that an entire message is sent from the source node to the destination node.

The protocol layers responsibilities include:

Prioritizing messages;

Splitting messages into small packets with well defined routing headers;

Discovering routes to a destination node;

Maintaining a routing table;

Interpreting received packets;

Insuring that no data is ever lost;

Responding to routing requests; and

Rerouting packets along optimized path.

Dynamic Source Routing (DSR) is derived from the concept of source routing. Each data packet specifies in its header the whole route to be traversed. A node, on receiving the packet, only needs to forward the packet to the next node in the list. This type of protocol is known as a reactive protocol. A signficant advantage of a reactive protocol is dramatic reduction in network load due to “Ping Flooding”.

The DSR protocol defines 3 components:

Route Discovery: Describes how to request a route and respond to such requests.

Route Maintenance: Explains how route problems (such as link breakage) are reported and recovered.

Data Forwarding: Describes how packets are delivered to their destinations, such as the format of data packets and routing tables.

Route Discovery: On a source node needing a route to a destination node, it broadcasts a route request packet containing the address of the destination node. On a node receiving this request, it will immediately respond with the full route to the destination (if known by this node) or it will append its own address to the packet and propagate the request packet to its neighbors. When a destination node receives the request packet, it will respond with a route reply packet containing the full route the packet traversed. The more nodes that are traversed by the request, the more potential route replies the source node may receive. These replies can be stored in a actively maintained cache sorted by best route.

Route Maintenance: Each connection between nodes is weighted to determine best overall route. Therefore, the best route can be determined by the route with lowest overall weight. This is determined for routes what have the best weight, not just shortest path. Weight is determined by both signal quality and network congestion at the node. Weight is determined using a running average of last several transmissions. This helps load balance the network, which reduces the variance in degree of path overlapping, and hence improves overall network performance.

Route maintenance can be done dynamically by every node that can sense packets being sent across the network; whether they are actually a source, intermediate, or destination nodes. Every packet has a full path in the packet header. Given the fact that wireless transmissions are broadcast in nature, each node that receives a broadcast can update its routing cache with new routing information.

Data are forwarded in the following manner: To send a data packet, a source node will specify the complete route to be traveled by the packet. Each intermediate node, on the receiving the data packet, looks at the route and forwards the packet to the next node. If the intermediate node has a shorter route to the packets destination in its own cache, the packet is redirected along the shorter route. If the new, shorter route, does not deliver the packet to the destination, the packet is resent along the original route.

Node Identification: Each node that is a producer/consumer of data will require a separate computer to accomplish the following tasks:

Identify itself to the server as a producer/consumer.

Ability to assign addresses to each producer/consumer at a individual node.

The ability to send and receive data/messages.

User interface for setting up node and messaging

A node will be located in the recorder vehicle. However, like any other node in the SeisWAN network, the Recording System server does not control, or act as a server for SeisWAN.

The Network Throughput for a data stream will be reduced by the number of nodes the data must pass. Maximum penalty is reached at three nodes. This means that a data stream passing through ten nodes would theoretically obtain the same throughput as a stream passing through 3 nodes. The reason for this is that the source node may transmit another packet when the previous packet has reached the third node without interfering with the previous packet. Therefore, the destination node would receive a packet every three intervals.

Throughput Estimation: If we assume that our radio throughput capabilities is 1 Mbps and we assume that the contention window and ACK period is 20 percent of a transmission cycle, then we can make the following theoretical assumptions about the throughput:

800 kbps for 1 hop transmission.

400 kbps for 2 hop transmission.

266 kbps for 3 hop transmission.

266 kbps for >3 hops transmissions.

This estimate does not take into account for random packet collisions, route loss, or time spent waiting for another transmission to finish. The more hops a transmission has to traverse, the less likely that the optimal transmission rate will apply.

SeisWAN provides a generic building block to construct a dynamic, low maintenance, fault tolerant, wireless communications system. It provides for efficient management of a great diversity of communications needs in the same system through the use of Virtual LANs. A central communication authority is not needed for SeisWAN though SeisWAN could service these devices.

The method, system and apparatus of the present invention provides:

Dynamic Node Configuration.

Dynamic LAN management—i.e. after each node in a LAN is identified as a member of the LAN, the node can join and leave the LAN without fatally disrupting the LAN.

Dynamic Communications Routing with optimization, and load balancing (sometimes the most optimum route is not the ideal or best route. These two factors are used in determining the best route).

Built in Data compression (can be switched on or off).

Heterogeneous communications equipment and behavior (on the physical level).

Nodes capable of operating as repeaters, routers, and application platforms, all at once, if needed.

A node does not need to be in direct contact with the destination node it wishes to communicate with. Data is routed through the intervening nodes to reach the destination.

Implementation and management of Virtual Networks.

Virtual Communications Connections.

Virtual node Identification, with multiple VIDs per node (this is quite unique).

Communications Fault Tolerance without loss of data.

Communications security by strong data encryption.

Telemetry, digital control of, and communications with electronic controls.

Tracking of mobile physical assets and nodes when combined with GPS receivers.

GPS position can be used to keep track of “dropped” ground nodes. Support personnel can plug a GPS receiver into a port in the node to “set” that nodes position. The node will store the last GPS position it received and report its position when queried. This will serve two purposes. First, it can be used to observe LAN coverage at a remote computer. Secondly, it can be used to help find lost nodes.

Transforming asynchronous communications and events into a system that behaves as a synchronous communications system.

Prioritized communications.

SeisWAN is a communications system that transforms asynchronous communications between two or more nodes (radios, equipment that generates data that needs to be communicated, etc.), into a communications system that behaves in a synchronous manner. In an asynchronous system, any node can begin communicating, or transmitting at any time. When two or more nodes transmit at the same time, the messages can, and will, become corrupt and the data being transmitted can be lost. In the Geophysical Exploration industry, the current solution for these collisions of messages is user intervention, and multiple radios transmitting on different frequencies. User intervention comprises verbal communications, and retransmission of data, or repeating the steps and events that generated the data to be communicated.

SeisWAN provides the ability to compartmentalize the previously mentioned nodes into logical groups and categories, so that communications within one group will not disturb the communications in another group. In a typical field data acquisition scenario, a seismic field crew may have 1 or more groups of vibrators (a seismic energy source), a support crew, data acquisition instruments, data storage boxes, and so on, all linked by any combination of wired and wireless telemetry. At the present time all these groups may be communicating on the same radio, but on different frequencies. At some point in the system, such as the “command center”, in order to communicate with all the different groups, the command center would have to have a different radio for each group. If every group communicates on the same frequency (as different groups of vibrators do), then there is a much greater possibility of communications conflict. There is no set protocol for communications between groups, so this remains a cumbersome error prone process.

SeisWAN does not require a “Network Operations Center”, “Network Servers” or physical “communications hubs” to implement or operate. It can have, but does not require, connections to the internet, or satellite communications.

In typical networks (wired and wireless) a broken connection can break the network. SeisWAN assumes that communication connections can become broken, and takes steps to preserve data, preserve the operation of the application using the connection, and dynamically reconnect to the system when the connection is restored. When the connection is restored, communications resumes where it left off.

Because of these design differences between SeisWAN and other wired and wireless networks, SeisWAN can use its own packet switching protocol.

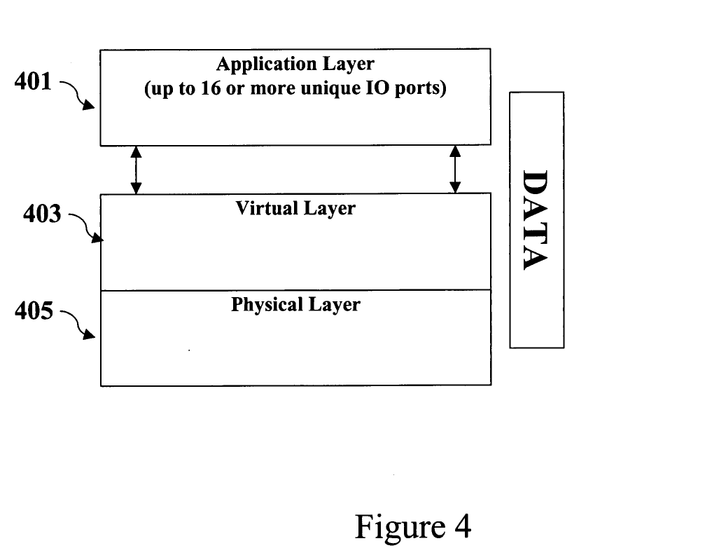

SeisWAN, as shown in FIG. 4, is comprised of at least 3 main parts described as “layers” (the method is not limited to three layers, though three will be used in this example-more layers may be included as may seen when compared to FIG. 1). At the lowest level is the physical layer 405. In the middle is the virtual layer 403, and at the top is the application layer 401. Data is moved between these layers, with the Physical Layer at the bottom, and the Application layer at the top.

The physical layer consists of the actual radios, computers, and software that compose a “communications node”. These nodes could physically differ from each other, but will behave in a homogeneous manner. At the physical level, all messages exist as packets of data. This means that a node makes no distinction between voice, video, other analog, or data messages.

Every node:

Has a radio that has the capability of transmitting to and receiving from any other node in the system (if the nodes are within range of each other).

Is capable of storing and retrieving data (messages).

Has a unique Physical Identity (PID) or physical address (PAD). This number is generated (and installed) either automatically or by the manufacturer.

An address contains the node's PID, crew number, and port that the producer/consumer is attached to. Each node can have separate addresses assigned to it (for example 16 separate addresses). These addresses are assigned dynamically by the Application Layer, via the Virtual Layer. Note: This addressing nomenclature is specific to the Seismic industry, but exists in SeisWAN as generic numbers. Therefore, other applications could call the “crew number” anything it wanted, and have the same affect.

Has router capabilities:

Generates dynamic “routing tables”

Determines close to optimal routes to destination nodes

Detects and handles message collisions

Manage prioritized message packets. Message packets of higher priority will pre-empt messages packets of lower priority.

Etc.

Is capable of mobile and stationary operations. The node will continue to function regardless whether it is mobile or stationary.

Can dynamically adapt to a continuously changing topology by dynamic routing.

Is capable of operating even if its communications link is temporarily out of range with all other nodes in the system. All data is preserved.

Can act as a repeater, whether stationary or mobile, without any changes to software, hardware or configuration. This ability extends the communications range of the individual nodes. This repeater function acts automatically and transparently to the other layers of SeisWAN.

Can dynamically join, and leave the system any number of times, without any loss of data, or (optimally) without any disruption to the operation of the application layer of the node. This is done without disruption to any other node or collection of nodes in the system. These operations are done without the need for any user knowledge, or intervention.

The Virtual Layer constructs implements, and manages Virtual LAN's, Virtual Connections, and the Virtual Identity (VID) of the node. In SeisWAN, a Local Area Network exists as a logical, virtual, concept. The Virtual LAN's are constructed as a serverless, peer-to-peer network. Membership in a Virtual LAN is controlled by the VID of the node. This layer handles the translation between the VID and the Physical Address (PAD).

The Virtual Connection is for the use of the Application Layer. The reason for a Virtual Connection is the fact that the Physical Connection between nodes can become temporarily (from seconds to days) disrupted. In many operations, the Application Layer will act mainly as a data producer. As such, the Virtual Connection can receive and locally store the data from the Application Layer, regardless of the state of the Physical Connection. This Virtual Connection serves to absorb and handle (as much as possible) disruptions to the Physical Connection. When the Physical Connection is functional, any stored data will be transmitted to the destination via the Physical Layer. Those applications which require information about the current state of the Physical Connection will be able to obtain that information from the Virtual Layer.

The Application Layer is where one or more application program(s) operate. These are applications that require communications with other nodes, for example such as a Vibrator controller that must receive configuration data, operation commands, and must transmit data that is generated by the Vibrator operations.

When coupled with GPS receivers, the SeisWAN nodes become a powerful building block for physical asset, physical infrastructure, and human resource management. With SeisWAN nodes, it becomes possible to build a wireless communications infrastructure for almost any communication need or application for information transfer, including but not limited to seismic data acquisition operations or utility services monitoring for homes, businesses and municipalities, using a wireless network with a virtual enabling data communication and storage over multiple environments, hardware systems and time frames.

One embodiment as provided by the method, system and apparatus of the present invention is for using SeisWAN for the operation of Pelton Company's dynamite blaster, the ShotPro: In one actual operation using the ShotPro, “normal” radio communications was so degraded, that the ShotPro could only receive its start command from the Recording System. Normally, the results of the start command would be transmitted back to the Recording System. In this situation, the result data could not be received by the Recording System. The result data would have to be stored locally in the ShotPro. Every couple of days, the operator of the ShotPro would have to physically travel to the location of the Recording System, and transfer the stored data (via a physically wired connection) to the Recording System. (Note: not all dynamite blasters have this capability. Even with this capability, the recording system can have problems processing this data when it is not received in real-time). SeisWAN solves this problem in a couple of ways. First, several SeisWAN nodes can be placed in strategic locations that function as repeater nodes, so that the ShotPro result data is transmitted to the Recording System as the data are generated.

Second, if the location where the ShotPro is operated is temporarily out of range of any repeater node, the data generated is stored in the SeisWAN unit. The operator can then travel (a much shorter distance) within range of a SeisWAN repeater node, and then the stored data can automatically be sent to the Recording System.

Using SeisWAN for the operation of Vibrators in Geophysical Exploration: In this example, there can be several groups of vibrators, where each group can have multiple vibrators. Normally, each group will be operating in different areas of the prospect (field acquisition area), but at the same time, operating unsynchronized relative to other units. The operation of all the vibrators in a group must be synchronized. Once all the vibrators of a group are ready to operate, a designated operator will indicate by voice or by digital message (via radio), to the Recording System, that the group is ready to operate. There is nothing to prevent similar transmissions from other groups to happen at the same time. If another vibrator group is operating, and using the radio to transmit telemetry data, or result data at the end of an operation, all other groups are prevented from transmitting.

In order to start the operation of a group of vibrators, several digital messages must be transmitted from the Recording System. While these messages are being sent, the other radio's MUST NOT transmit. The operators of this system could use multiple radios and frequencies, but communication operations become complex, are still error prone, and expensive. The person operating the system must be highly skilled in managing the radios. The setup, testing, and maintenance of such a system can be difficult, expensive, and fraught with problems.

To add another dimension to this situation, there is a group called “support vehicles” that are used to transport maintenance workers to maintain the assets used in Geophysical Exploration. These vehicles and workers must be tracked, and need communications of their own, independent of the operation of the vibrators. These communications are of a lower priority than the communications of the vibrators and the field data acquisition hardware. In many cases these resources could be utilized more advantageously with a SeisWAN system.

With SeisWAN, all of the asynchronous messages that occur can be handled automatically, without the collision problems that plague the current manual systems. Since the messages can be prioritized, the start operation messages can be sent from the Recording System, even during high message traffic conditions, without losing any data or time. Lower priority messages would be delayed slightly, but would continue without disrupting the applications sending or receiving them. The system would behave as an efficient synchronous communications system.

Each vibrator group and the support vehicles would be organized and configured as independent LANs. This would enable communications between nodes in the networks. So, when a group of vibrators become ready for operations, there no longer needs to be any operator intervention to communicate to the Recording System (as before). The vibrators can communicate between themselves, and when they are all ready, a message can be automatically sent at that moment, without regard to any other operations taking place external to that group.

Using a digital messaging system, the support vehicle LAN could receive and act on lists of what needs to be done. Then, communicating between themselves using the same system (without regard to location), decide who does what.

On the physical level, since every SeisWAN unit can and will act as a repeater and router, the whole system can dynamically adjust to changing conditions and possible communication break-downs. With dynamic routing, if one route between nodes becomes unavailable, another route can be implemented, without user intervention or knowledge. If no routes are available, no valuable data will be lost.

The routing of data along the LAN is based on the concept of “Load Balancing”. Load balancing helps to insure fairness across the LAN. This means that the shortest route to the destination is not always the best route. Best routes are based on the weight of the route. The weight of the route is determined by several factors, including:

Age of a route (old routes are less reliable on a mobile network)

Network congestion at specific nodes (these nodes should be avoided, if possible)

“Lost” data between nodes. The data is not really lost, as the sending node still has the data. This just implies that the receiver is chronically receiving incomplete messages, and there needs to be a retransmission of the data. Load balanced routing reduces the variance in degree of path overlapping and increases the efficiency of LAN utilization.

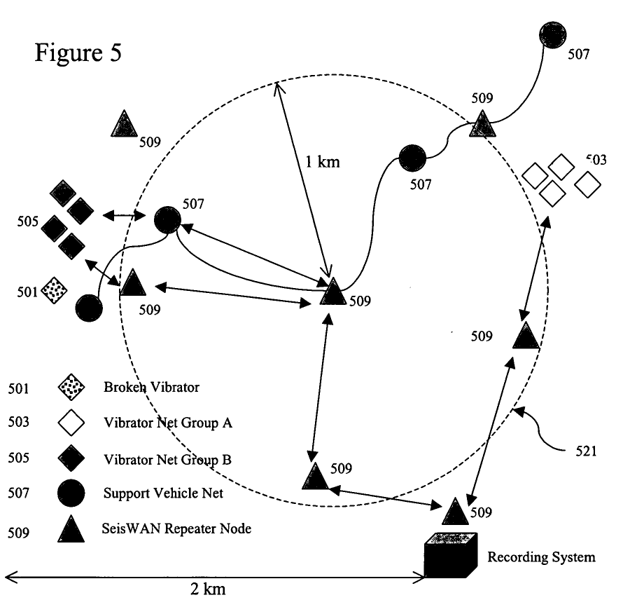

FIG. 5 is an illustration of an embodiment of the method, system and apparatus of the present invention where disparate components of an acquisition system are illustrated. While the example illustrated here is from the Geophysical Exploration industry, it will be appreciated that the method, system and apparatus have application to any information gathering and monitoring endeavor, such as utility services monitoring for homes, businesses and municipalities. Since the Vibrator Groups 503, 505 (seismic source generators) are usually so close together, no communication lines have been drawn. Communication routes between the Support Vehicles 507 are represented by the lines joining Support Vehicle symbols 507. The two-way arrows represent communication routes between the repeater nodes. As may be seen from examining the illustration, many alternate communication routes are available, as any node in the system has a radius of communication of approximately 1 km in this example. The circle 521 represents the general coverage area of a 1 KM radius for the SeisWan Repeater Node 509 in the center of this example layout. A SeisWAN repeater node can be established as an auxiliary to or with any piece of equipment, or may be a dedicated instrument serving only the purpose of a repeater. Each SeisWAN node in this example would have approximately the same coverage area, depending on local features and conditions.

Most data generated by the Vibrator Groups would end up at the Recording System. Note that the Recording System does not control, or act as a server for SeisWAN.

Although the examples given here are only from the Geophysical Exploration industry, there are many other industries and situations where SeisWAN could be used. In some cases, SeisWAN could replace the use of expensive cellular phone service that is used in some applications.

Municipality Infrastructure Management and Communications

Utility assets monitoring (valves, pipelines, transformers, unattended property, etc.)

Utility meter data collection

Traffic light monitoring

Mobile service assets/personnel tracking

Communications via digital messaging to enhance “normal” radio dispatching

Law enforcement communications and tracking

Public School assets monitoring, mobile and stationary

Public transportation

Public safety

Communications infrastructure to implement “Augmented Reality” systems.

Warehouse complexes

Office complexes

Unattended oilfield production sites and equipment

Factories and refineries

Railroad yard complexes

In those municipalities that implemented SeisWAN throughout their community, it is possible to implement inexpensive tracking systems for the personal safety of Alzheimer patients, at-risk children and adults, persons on probation and parole, fleets of delivery vehicles, and other mobile assets and persons. This system could also be used to provide connectivity to public service vehicles such as police cars. These vehicles have networked computers for accomplishing various tasks such as querying license plate numbers, finding addresses, and viewing criminal histories.

In an alternative embodiment the method, system and apparatus of the present invention provides for efficiently gather utility services information, for the following example of a County Water System where a wireless system can monitor the water system from reservoir, or water source, to the final end-user meter readings. The communications system here is referred to as “ARCS”, for “Area Radio Communications System” and is analogous to SeisWAN. ARCS is composed of communications modules referred to as a “RIBB”, for “Radio Infrastructure Building Block.” Of course, the actual name of the product implementation that conforms to the specifications herein may be different.

“Application” refers to a data producer and data consumer that is actually separate from ARCS. An “application” would make use of ARCS to facilitate data communication between a data source and a data consumer. “Data producer” refers to any component, whether hardware, software, or combination thereof which produces data of any kind. A data producer can also be a data consumer. “Data consumer” refers to any component, whether hardware, software or combination thereof which consumes data of any kind from a data producer. A data consumer can also be a data producer.

Overview of the Communications System: Purpose of ARCS: The principal purpose of ARCS is to provide and manage all of the data communications needs of the proposed County Water System. ARCS provides a homogeneous communications infrastructure. This means that regardless of the components used to implement the system, the behavior of that system will be consistent and uniform. (Some specialized subsystems that integrate with ARCS may need to deviate from this, but these subsystems should also be homogeneous in nature). ARCS is able to handle multiple unrelated data streams whose sources and destinations can be both mobile and fixed. It is important to note here, that any data stream that is input to ARCS can be directed to the data consumer, regardless of the producer or consumer's present location in the system, and regardless as to whether that producer or consumer is mobile or stationary at any time. The only requirement is that the consumer must be in communications range of the ARCS system.

Architecture of ARCS: The communications architecture is peer-to-peer. ARCS operates without the need for a server. Each RIBB in ARCS acts as a data router, and as a repeater, automatically, as needed. Since the future data acquisition communications needs of this water system are difficult to predict, ARCS is extensible, able to provide an infrastructure that can host multiple applications from multiple vendors, without disturbing existing communications. Given the extensible nature of this system, the interface to ARCS will be an open architecture application for any provider who needs to interface their equipment or application with ARCS. This interface will remain the property of the provider of the interface.

Method of ARCS: The communications system is to be wired and/or wireless, but in the usual case is predominately wireless. Area Served by ARCS: The area of this communications system is from the water source, to the water treatment facility, and to any meter where the water is consumed. It is envisioned that there will be almost full coverage of each municipality that this water system serves. The scope of the system includes any data producers and data consumers the service area.

Data Preservation: Since data producers and consumers can be mobile, and connections between the producer and consumer can be broken for various reasons, ARCS provides data preservation features. This means that if communications from a data producer to a data consumer is broken, the data are preserved in the system until communications with the data consumer are restored. The amount of data saved will be dependent upon the amount of memory available in the RIBB where the data stream enters ARCS.

A Meter Reading Communications Subsystem is interfaced with ARCS. The Meter Reading Communications Subsystem is referred to as “INet” which means “Instrument Network.” INet is the communications component of the Meter Reading System, and may be separate from the other components that make up this system. The INet communications system uses a subset of the features of ARCS and operates in a similar manner. INet enables data from specific data producers (instruments, in this case, meters) to be sent to ARCS, which will forward the data to the consumers. This will enable completely automated data acquisition, by the data consumer application. Architecture of INet: The communications architecture is peer-to-peer. This subsystem operates in a manner analogous to ARCS. An INet subsystem can be deployed for a specific application, or class of applications, such as reading meters. As a result, INet is not as extensible as ARCS. INet will connect to ARCS by a RIBB acting as an INet to ARCS gateway.

The ARCS communications system is to be predominantly or completely wireless. Area Served by ARCS: Collections of INet systems will cover all the municipal meters. The rural meters will probably have to be served by RIBB's. Scope: Each INet node will be able to communicate with three different meter readers (Water, Gas and Electric or any combination). In addition, each Net node will have a signal available to activate or deactivate a shut off valve for each meter served. Data Preservation: Data will be preserved by the instrument itself, or by the ARCS gateway. The memory resource of each INet node is limited.

While the foregoing disclosure is directed to the preferred embodiments of the invention, various modifications will be apparent to those skilled in the art. It is intended that all variations within the scope and spirit of the appended claims be embraced by the foregoing disclosure.

What is claimed is:

1. A wireless communication system comprised of nodes, said nodes comprising:
a. a physical layer;
b. a virtual layer; and
c. an application layer.

2. The system of claim 1 further comprising at least one of: i) a protocol layer, ii) a Media Access Control layer, and iii) a Hardware Abstraction layer.

3. The system of claim 1 further comprising an application interface layer.

4. The system of claim 1 wherein the virtual layer enables data storage and transfer between any layer.

5. The system of claim 1 further comprising a communication routing table that dynamically changes geometries of node positions to direct communication routes.

6. The system of claim 1 wherein the physical layer further comprises a connection to a GPS receiver.

7. A method of wireless communication comprising:
a. a physical layer for acquiring input data;
b. a virtual layer; and
c. an application layer.

8. The method of claim 7 further comprising at least one of: i) a protocol layer, ii) a Media Access Control layer, and iii) a Hardware Abstraction layer.

9. The method of claim 7 further comprising an application interface layer.

10. The method of claim 7 wherein the virtual layer enables data storage and transfer between any layer.

11. The method of claim 7 further comprising a communication routing table that dynamically changes geometries of node positions to direct communication routes.

12. The method of claim 7 wherein the physical layer further comprises a connection to a GPS receiver

13. A wireless communication apparatus comprising:
a. a physical layer connected to a device for acquiring input data;
b. a virtual layer; and
c. an application layer.

14. The wireless communication apparatus of claim 13 further comprising at least one of: i) a protocol layer, ii) a Media Access Control layer, and iii) a Hardware Abstraction layer.

15. The wireless communication apparatus of claim 13 further comprising an application interface layer.

16. The wireless communication apparatus of claim 13 wherein the virtual layer enables data storage and transfer between any layer.

17. The wireless communication apparatus of claim 13 further comprising routing table that dynamically changes geometries of node positions to direct communication routes.

18. The wireless communication apparatus of claim 13 wherein the physical layer further comprises a connection to a GPS receiver

19. The wireless communication apparatus of claim 13 further comprising a memory storage device.
